(19) United States
(12) Patent Application Publication
(10) Pub. No.: US 2010/0230576 A1
(43) Pub. Date: Sep. 16, 2010

(54) Snow block apparatus

(76) Inventor: James C. Pendergast, Racine, WI (US)

Correspondence Address: The Hill Firm;Suite 1201, 666 Dundee Road, Northbrook, IL, 60062, US

(21) Appl. No.: 12/381,397

(22) Filed: Mar. 11, 2009

(51) Int. Cl. B29C 33/42

(52) U.S. Cl. 249/140; 249/141

(57) ABSTRACT

A five-sided open top forming mold for material such as snow having peripheral walls with in-turned flanges at a bottom thereof, a mold bottom adapted to rest against the in-turned flanges, inter-engaging edge portions of the bottom and configurations on the walls retaining the bottom in place until application of a force sufficient to overcome the retention whereby the bottom can push the molded material out of the mold, and the bottom can be re-snapped into position at the bottom before another material molding.

### BACKGROUND OF THE INVENTION

1. Field of the Invention

This invention relates to molds and more particularly to a mold for use in forming snow blocks.

2. General Background

It is common for children and adults in those parts of the world having heavy snowfall or beaches to form structures from the snow or wet sand. Oftentimes such structures are formed from blocks or other shapes that have been formed by compressing the snow or wet sand into a container such that the compressed material takes on the shape of the interior of the container. Numerous examples of such molding systems exist, such as shown, for example in U.S. Pat. No. 3,685,942 where the molding member is formed as a scoop, or U.S. Pat. No. 2,752,631 where the molding member is formed as part of a snow shovel or U.S. Pat. No. 3,713,431, where the molding member is formed of a four-sided housing and an L-shaped scoop and compressor, which interfits with the housing to form the block or the five-sided mold of U.S. Pat. D246,664. Many means of extraction of a formed block have been proposed, such as the ejector shown in U.S. Pat. No. 3,859,029 or the strap shown in U.S. Pat. No. 3,848,846.

While such molding systems assist in providing shaped snow blocks, and address, in differing designs, one or more of approaches to a snow molding form, however each design has deficiencies associated therewith, which are overcome with the present invention.

### SUMMARY OF THE INVENTION

The present invention provides a forming mold for molding snow or wet sand into a block shape conforming to the interior dimensions of the mold. The mold is provided with sidewalls having an initial upward and outward taper to facilitate funneling of snow into the mold body, a secondary taper to facilitate release of the packed material from the mold body, a down-turned exterior skirt spaced from the sidewall of the mold extending downwardly from adjacent the top of the sidewalls, which can provide a gripping surface for lifting the mold but which also functions as a protected attachment point for a bail with the free ends of the bail residing between the sidewall and the downwardly extending outer flange. The sidewalls terminate at their end opposite the open top end in an in-turned flange, which provides support for a removable bottom. A bead or a series of beads is formed on the interior of the sidewalls spaced from an upper surface of the in-turned flange by a dimension approximately equal to the thickness of the removable bottom, whereby the bottom can be snapped into place between the bead and the flange. The bottom is provided with openings therethrough allowing for drainage of water during the snow compaction process. If desired, a secondary cover may be provided to fit within the flared section of the upper portion of the sidewalls to assist in compacting the snow into the mold, however such an additional top piece is supplemental since children using the mold can easily push the snow into shape with their hands.

It is therefore an object of this invention to overcome deficiencies in prior art snow molds and to provide a simple, easily constructed, inexpensive snow mold.

In an embodiment of the invention the snow mold comprises a four-sided mold member having an in-turned flange at the bottom of the sidewalls, a removable bottom member received against the in-turned flange and held in place thereagainst by interference fit projections on an interior surface of at least some of the sidewalls spaced from the in-turned flange.

In a further embodiment of the invention, the mold consists of a four-sided main mold member defined by sidewalls having tops and bottoms, the sidewalls at the top being flared outwardly with respect to remaining portions of the sidewalls and terminating in a downwardly extending skirt spaced from the sidewall, the mold being provided with a removable bottom conforming to the interior dimensions of the sidewalls adjacent a bottom thereof.

In an embodiment of the invention, a mold body is provided having a plurality of sidewalls forming an enclosure, the sidewalls having bottom forming in-turned flanges leaving the majority of the bottom of the enclosure open, a removable bottom plate is insertable into the body against the in-turned flanges, releasable projection means are formed on the inside surfaces of at least some of the sidewalls effective to hold the bottom in above against the flange but to allow the bottom to snap out of position to be removed through the top of the mold body thereby pushing the contents of the mold from the enclosure, the bottom being provided with drainage openings therethrough.

It is therefore a general object of this invention to provide an improved snow mold for use in molding snow into blocks or other shaped three-dimensional solid or semi-solid forms and to provide for easy removability of the formed shape from the mold. This and other objects will be apparent to those of ordinary skill in the art from the description of the preferred embodiment and giving reference to the accompanying drawings.

### BRIEF DESCRIPTION OF THE DRAWINGS

FIG. 1 is a perspective view of the mold according to this invention showing the bottom positioned outside of the mold body.

FIG. 2 is an enlarged cross-section view generally along the lines ii-ii of FIG. 1.

### DESCRIPTION OF THE PREFERRED EMBODIMENT

As shown in FIG. 10, the apparatus of this invention consists of a mold 10 formed generally as a four-sided surround 11 having end sides 12 and 13 and long sides 14 and 15, the mold being shown as rectangular. The sides join at rounded edges 16. It will be understood that the mold could be square or formed from shaped side walls into other shapes and could, for example, be formed on an arc or curvature to form different types of blocks of snow or other compatible material.

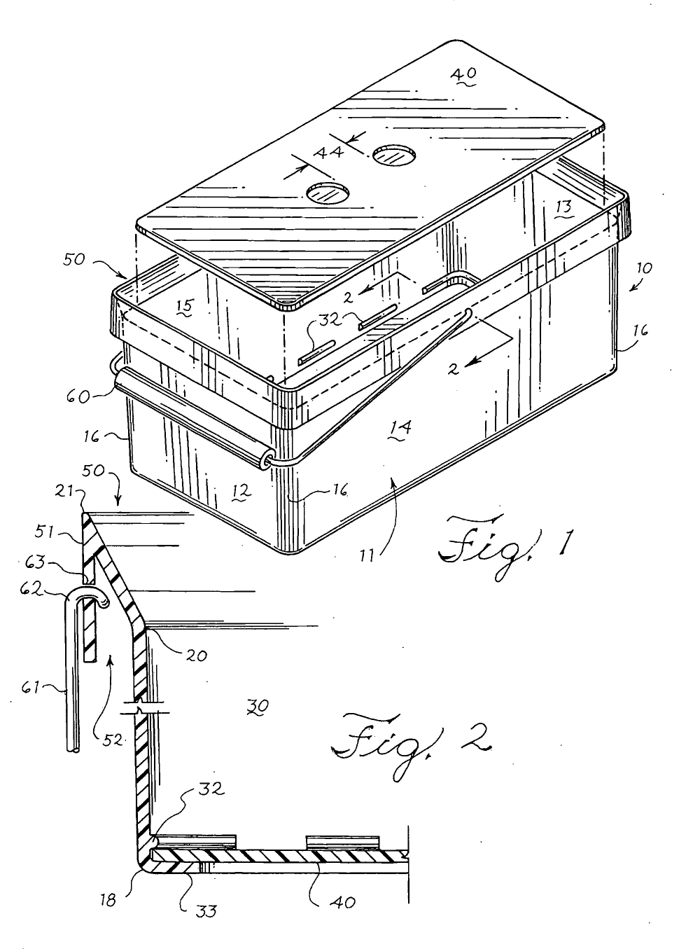

FIG. 2 is an enlarged partial cross-section taken generally along the lines ii-ii of FIG. 1 and illustrates sidewall 14 which is tapered slightly outwardly from an inside corner bottom 18 upwardly to a intermediate point 20 spaced from a top 21 of the wall 14. The wall portion between the intermediate point 20 and the top 21 tapers outwardly at a greater angle than the taper between the bottom corner 18 and the intermediate point 20 so as to form essentially a funneling surface for funneling snow into the main body section 30 of the mold. An inwardly projecting bead 32 is positioned above an in-turned bottom flange 33 by a distance approximately equal to the thickness of a mold plate bottom 40. The mold bottom plate 40 is removable from the mold by snapping it upwardly past the bead and distorting the bottom 40 enough to snap around the bead. The material of the bottom plate 40 is of a plastic having a resiliency sufficient to allow it to snap into position between the bead 32 and the in-turned flange 33 and to snap out of it under pressure pushing it towards the open top 50.

The bead may, as shown in FIG. 1, be substantially continuous extending entirely around the periphery of the mold body 14 or, as shown in FIG. 2, may be intermittent, reducing the amount of force necessary to remove the bottom from the position between the bead and the in-turned bottom flange 33. The bead creates an interference fit with the undistorted shape of the bottom plate 42.

An outer skirt 51 extends downwardly from the top 21 in spaced relation to the walls 12-15 forming an opening 52. Preferably the skirt 51 extends substantially parallel to the lower section of the walls, which, as mentioned above, are slightly outwardly tapered. The skirt can be straight or slightly outwardly tapered itself. The skirt forms a gripping area so that a person, perhaps equipped with mittens or gloves, can grab the mold from around its periphery. Preferably the entire mold is formed of a sufficiently resilient plastic that a child's finger would not get stuck in the space 52. The skirt also allows for a wider top which is preferably not sharp edged.

The skirt 51 can also serve as the attachment point for a bail 60 formed of a generally U-shaped wire member 61, which has hook ends 62 extending through openings 63 in the skirt and being bent into the space 52 so as to resist removal. Although I've shown the mold as utilizing one bail, it can be understood that the mold may have two bails, one closer to the wall 12 and wall closer to the wall 13, the bails being long enough the be brought together over the center of the mold to aid in lifting. The bottom 40 is provided with openings 44 therein, which will allow drainage as the snow is compacted into the mold body 14.

In the preferred embodiment, as shown the openings 44 may be formed as finger holes to allow the bottom to be maneuvered both to snap it into position and to pull it out of position when the mold is empty. Generally, in use of the mold, snow or wet sand or other formable material will be molded into the mold body 14, with the aid of the funnel shape of the top portion of the walls, and with the bottom in place. A second bottom shaped member may also be provided to aid in compacting the material into the mold to approximately the height of the intermediate section 20 of the sidewalls thereby forming generally a rectangular block as shown in the mold embodiment illustrated. The bottom can then be pushed upwardly or, upon inversion of the mold, downwardly, to break loose the compacted formed block by snapping the bottom 40 beyond the bead 32. The tapered wall portions will aid in release of the formed block.

If desired, the inside of the walls may be formed with vertical ribbing or the like to add detail to the formed block or the top and/or bottom surface of the bottom may be provided with a three dimensional feature or indicia, such as the words “snow mold” as illustrated to impress into the molded block, a feature, including advertising, which will then form part of the top of the block as the mold is inverted and the block is pushed out.

From the above it will be appreciated that this invention provide an improved block-forming mold for use in compacting snow, wet sand or the like into individual blocks, the mold consisting of an at least four-sided open top and open bottom enclosure with a snap-in, snap-out bottom, which in the snap-in position rests between a raised section on an interior wall and an in-turned flange at the bottom of the peripheral walls. A funnel-shaped top section of the peripheral walls aids in compressing quantities of loose snow or the like into the actual mold forming intermediate section where tapered walls assist in extraction of the molded block on inversion of the mold form. A peripheral downwardly extending skirt provides a gripping feature and a place for affixing the ends of a bail or bails without being projecting into the interior mold.

Although I have shown this invention in connection with a preferred embodiment, those skilled in the art will understand that it may be practiced in many different designs, variations and manufactured of many different materials and in different shapes.

I claim as my invention:

1. A block forming mold for compactable material such as snow comprising a mold member having at least four peripheral walls connected together at edges to form an enclosure, the enclosure having an open top and an open bottom, at least some of the peripheral walls having in-turned flanges at a bottom thereof, the peripheral walls having raised inwardly extending restraining members formed thereon spaced from the in-turned flange, a removable bottom plate having a top-to-bottom thickness of approximately the same as the distance between the top of the in-turned flange and the retaining members and being snappable into place under the retaining members atop the in-turned flange to form a bottom to the enclosure, the peripheral walls having top portions extending outwardly and upwardly away from each other forming a funnel-like opening to the interior of the enclosure, the peripheral walls terminating in a top, a skirt surrounding the peripheral walls extending downwardly from adjacent the top in spaced relationship to outside edges of the peripheral walls.

2. The mold according to claim 1 wherein the retention members comprise a raised bead formed on the inside surface of the peripheral walls.

3. The mold according to claim 2 wherein the raised bead is formed of a series of spaced apart bead sections.

4. The mold according to claim 2 wherein the peripheral walls extend upwardly and outwardly at a taper from the bead section to an intermediate point and then outwardly at a greater taper whereby the peripheral walls taper outwardly for ease of release of a molded block formed interior of the enclosure.

5. The mold according to claim 4 wherein the bottom has openings therethrough.

6. The mold according to claim 5 wherein the bottom has indicia thereon for forming surface irregularity features in the block being molded.

7. The mold according to claim 6 wherein the indicia are raised.

8. The mold according to claim 7 wherein a bail is attached to the enclosure through openings in the skirt.

9. A mold specifically adapted for compacting blocks of snow comprising a mold enclosure having at least four peripheral sides joined together to form an enclosure having an open top and substantially open bottom, the peripheral sides having in-turned flanges at bottom thereof and inwardly extending projections spaced from a top of the in-turned flange, a bottom forming plate having a thickness not greater than the distance between the top of the in-turned flanges and the bottom of the inward projections and having an overall dimension approximately the same as the interior dimension of the enclosure at the bottom of the peripheral walls whereby the bottom plate can be snapped into position resting on the in-turned flange held from falling out by the in-turned projections, the bottom plate being resilient sufficient to be pushed past the inward projections, the peripheral walls having a first taper from the projection to an intermediate point with the walls extending upwardly and outwardly, a second taper greater than the first taper extending from the intermediate point to a top edge forming a funnel surface for aiding in funneling snow into the mold interior, the bottom plate having drainage openings therethrough.

10. The mold according to claim 9 wherein a peripheral skirt extends downwardly and outwardly from the top spaced from the peripheral walls forming a gap there between, the skirt being integrated to the peripheral walls at the top.

11. The mold according to claim 10 wherein at least one bail is attached to the enclosure through openings in the skirt.

12. The mold according to claim 11 wherein the inward projection constitutes a bead extending substantially around the interior of the enclosure.

13. The mold according to claim 12 wherein the bead is intermittent.
